(19) United States
(12) Patent Application Publication
(10) Pub. No.: US 2025/0340488 A1
(43) Pub. Date: Nov. 6, 2025

(54) MINERAL WOOL ADHESIVE WITH REDUCED MOISTURE PERMEABILITY

(71) Applicant: Owens Corning Intellectual Capital, LLC, Toledo, OH (US)

(72) Inventors: Gregory Godard, Saint-Alban de Montbel (FR); Yogesh Deshmukh, Hilversum (NL)

(21) Appl. No.: 18/871,994

(22) PCT Filed: Jun. 15, 2023
(86) PCT No.: PCT/US2023/025361

§ 371 Date: Dec. 5, 2024

Related U.S. Application Data
(60) Provisional application No. 63/352,264, filed on Jun. 15, 2022.

(51) Int. Cl. C04B 28/14; B32B 5/02; B32B 5/26; B32B 7/12; C04B 22/02; C04B 24/34; C04B 103/65; C04B 111/00; C04B 111/27; D04H 1/4218

(52) U.S. Cl. CPC C04B 28/14; B32B 5/02; B32B 5/022; B32B 5/265; B32B 7/12; C04B 22/02; C04B 24/34; D04H 1/4218; B32B 2250/02; B32B 2250/20; B32B 2255/02; B32B 2255/20; B32B 2262/101; B32B 2262/108; B32B 2264/302; B32B 2264/303; B32B 2307/304; B32B 2307/7265; B32B 2419/00; B32B 2419/06; C04B 2103/65; C04B 2111/00637; C04B 2111/27; D10B 2505/00

(57) ABSTRACT

A mineral wool insulation product for insulating and/or waterproofing an exterior of a structure (e.g., a roof) includes a mineral wool substrate, a nonwoven fibrous facer, and a fluorine-free water-resistant adhesive. The adhesive is modified to have a reduced permeability and is provided at the interface between the mineral wool substrate and the nonwoven facer so as to limit water intrusion that might otherwise intrude into the product.

### FIELD

The present invention relates to insulation for structures including exterior sheathing, and more particularly, to systems and methods that avoid problems associated with intrusion of moisture occurring in e.g., mineral wool insulation systems.

### BACKGROUND

Mineral wool is an insulation material used in a wide variety of applications. The unique properties of mineral wool make it an effective choice for use in insulation applications including exterior building sheathing. While mineral wool insulation performs the necessary purpose of energy and heat retention, other problems may arise due to environmental conditions. For instance, when moisture is allowed to penetrate or otherwise migrate between the insulation and the surface of a substrate or structure, the insulation or structure can become compromised, necessitating costly repairs.

In certain applications mineral wool insulation is provided with a nonwoven fibrous facer. The facer may improve the mechanical strength of the insulation, enhance the aesthetic characteristics of the insulation, and protect it from the environment. However, both the mineral wool insulation and the facer are often porous, allowing moisture to penetrate, which is disadvantageous in certain applications. One method of preventing water intrusion into a mineral wool insulation product is to use a water-resistant glue when adhering the facer to the insulation or to coat the facer with a water-repellant coating. Often these water-resistant glues/coatings are comprised of fluorine-containing compounds to deliver the water-resistant characteristics. However, recent environmental regulations regarding fluorine-containing components has made their use unfavorable or impermissible in many applications.

### SUMMARY

Therefore, a need exists for an insulation product that can provide adequate insulation to structures (including roofing applications) in a variety of challenging environments, yet also prevent water intrusion while avoiding conventional fluorine-containing water-proofing materials.

The general inventive concepts are based, in part, on the discovery that certain modified cement-like adhesives (also called glues) can deliver good adhesion between a fibrous insulation material (e.g., mineral wool insulation) and a fibrous facer, while also providing fluorine-free moisture resistance. Mineral wool and conventional (fiberglass nonwoven) facers are inherently porous and provide little in the way of moisture resistance to the underlying structure. As previously mentioned, this issue was often dealt with by application of a water-resistant glue or coating to the faced insulation product (often via application to at least one surface of the nonwoven facer or through impregnation with fluorine-containing materials). The conventional fluorine-containing water-resistant additives have become disfavored. Thus, there is a need for a waterproof (or otherwise moisture resistant) fabrication adhesive for insulation applications that use mineral wool and nonwoven facers, including those that are exposed to the elements (e.g., on exterior building sheathing).

In certain exemplary embodiments, the general inventive concepts contemplate an insulation product comprising a unitary substrate including a plurality of interconnected first fibers (e.g., a mineral wool insulation substrate), a nonwoven facer including a plurality of interconnected second fibers, and a fluorine-free water-resistant adhesive material adhering the substrate and facer together. In certain exemplary embodiments, the fluorine-free water-resistant adhesive material is a modified gypsum cement comprising a solid component and a liquid component. In certain exemplary embodiments, the solid component comprises a gypsum cement base and the liquid component comprises a waterproofing element and water. In certain exemplary embodiments, the waterproofing element and the water are pre-combined to form the liquid component. In certain exemplary embodiments, the solid component and the liquid component are combined in a ratio of about 1:1 to about 3:1, including about 2:1 by weight. In certain exemplary embodiments, the modified gypsum cement comprises a gypsum cement base, water, and a waterproofing element present in an amount of about 5% to about 40% by weight of the gypsum cement base.

In certain exemplary embodiments, the general inventive concepts contemplate a method of manufacturing a faced mineral wool insulation product. The method comprises providing a mineral wool substrate and a nonwoven facer; mixing a gypsum cement base, water, and a waterproofing element to form a modified gypsum cement (e.g., fluorine-free water-resistant adhesive material), wherein the waterproofing element displaces a portion of the water; applying the modified gypsum cement to at least one of the nonwoven facer and the mineral wool substrate; and adhering the nonwoven facer to a surface of the mineral wool substrate. Unless the context dictates otherwise, the features and optional features of the first aspect (the insulating product) apply equally to other aspects discussed herein, including the second aspect (the method of manufacture) and vice versa.

In certain exemplary embodiments, the general inventive concepts contemplate a method of insulating a structure. The method comprises mixing a gypsum cement base, water, and a waterproofing element to form a modified gypsum cement (e.g., fluorine-free water-resistant adhesive material), wherein the waterproofing element displaces a portion of the water; providing a plurality of mineral wool insulation members and providing a plurality of nonwoven facers; applying the modified gypsum cement to a surface of each of the mineral wool members; positioning each facer on a surface of a corresponding one of the mineral wool members to form a plurality of faced mineral wool products; and positioning the faced mineral wool products about an exterior of the structure.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 shows an SEM image of the control gypsum cement without a waterproofing element. The image shows the typical open porosity of the cement which leads to a high moisture permeability.

FIG. 2 is an SEM image of the control cement formulated with a wax emulsion (i.e., a modified gypsum cement) showing the closed pore structure with a paraffin wax particle addition.

FIG. 3 is an SEM image of the control gypsum cement without a waterproofing element.

FIG. 4 is an SEM image of gypsum cement with a silicon emulsion waterproofing element (i.e., a modified gypsum cement).

FIG. 5A is an SEM image showing paraffin wax emulsion size and shape with an average particle size of between 0.5 to 20 microns in diameter.

FIG. 5B is a magnified view of the paraffin wax shown in FIG. 9A, showing paraffin wax particles with an average particle size of between 1 to 5 microns in diameter.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

While various exemplary embodiments are described or suggested herein, other exemplary embodiments utilizing a variety of methods and materials similar or equivalent to those described or suggested herein are encompassed by the general inventive concepts.

Unless defined otherwise, all technical and scientific terms used herein have the same meaning as commonly understood by one of ordinary skill in the art to which the invention belongs. In this connection, unless otherwise indicated, concentrations of ingredients given in this document refer to the concentrations of these ingredients in the master batch or concentrate, in keeping with customary practice.

Mineral wool insulation products (including mineral wool insulation with a fibrous facer) are semi-rigid, porous insulation materials that are used in a variety of insulation applications, including those that are exposed to the elements. However, the porous nature of the products reduces their utility in certain applications or necessitates the used of disfavored fluorinated glues/coatings that provide waterproofing or resistance.

Gypsum cements, made by combining a gypsum cement powder and water, are a conventional cement for certain materials and can provide benefits in terms of flame/fire resistance, but are not generally used in mineral wool applications. That being said, conventional gypsum cement used in fabrication is porous to moisture, which allows for water intrusion over time. Thus, conventional gypsum-based cements do not meet the needs of mineral wool-based insulation systems.

Applicants have also found that, due to the porosity of gypsum cement-based adhesive materials, a typical hydrophobic additive (i.e., a coating applied to the exterior of the cement) is not effective at providing water resistance or stopping water permeation in many systems. The general inventive concepts are based, in part, on the discovery that certain agents (e.g., waterproofing elements) perform much better at blocking/closing the pores of gypsum cement when added as a part of the cement mixture and displacing a portion of the water that would otherwise be used in the cement mixture. SEM images shown herein clearly show the high porosity of conventional gypsum adhesives in contrast to those that have an additive with mostly blocked pores when made according to the inventive concepts.

While not wishing to be bound by theory, Applicants believe the porosity of the cement is decreased by occlusion of the pores of the unmodified gypsum cement microstructure by using the waterproofing element in the cement mixture (and replacing/displacing a portion of the water that would otherwise be added). In certain exemplary embodiments, the waterproofing element is one of a wax emulsion and a silicon emulsion, as discussed herein in greater detail.

Therefore, the general inventive concepts contemplate a new cement composition for fabricating faced mineral wool insulation products. The new formulation comprises a gypsum cement base combined with water and a waterproofing element that displaces a portion of the water that would otherwise make up the conventional (i.e., unmodified) cement mixture.

The term “gypsum cement base” as used herein, refers to the dry ingredients of a conventional gypsum cement (e.g., the solid component). For example a commercial product such as Hydrocal® B11 sold by U.S. Gypsum.

The term “gypsum cement mixture” as used herein refers to the combination of a solid component and a liquid component (e.g., gypsum cement base and water).

The term “fluorine-free water-resistant adhesive material” as used herein, refers to adhesives, glues, or cements that are substantially free of fluorinated compounds. The fluorine-free water-resistant adhesive material should provide effective adhesion between mineral wool substrates and nonwoven fibrous facers, while also limiting water intrusion. The term is meant to refer to adhesive materials with less than a functional amount of fluorinated components, but those of ordinary skill in the art will recognize that certain ingredients of adhesives may have inherent fluorine by-products or contaminants and can still fall within these concepts. In certain exemplary embodiments, the fluorine-free water-resistant adhesive material is a modified gypsum cement.

The term “modified gypsum cement” as used herein, refers to a gypsum cement mixture, optional water, and a waterproofing element. In certain exemplary embodiments, the solid component (e.g., the gypsum cement base) and the liquid component (e.g., waterproofing element and water) of the modified gypsum cement are combined in a ratio of about 1:1 to about 3:1, including about 2:1 by weight.

The term “waterproofing element” as used herein, refers to a chemical composition that, when added to a gypsum cement mixture, reduces the permeability and permeance of the gypsum cement. When incorporated according to the general inventive concepts, the waterproofing element displaces a portion of the water that would otherwise make up the liquid portion of the gypsum cement mixture.

The term “displacing a portion of the water” as used herein, refers to a modification of the formula for making a gypsum cement mixture or modified gypsum cement mixture. The modification entails replacing a portion of the water (or other liquid portion) that would otherwise be used to make a conventional gypsum cement mixture (e.g., a recipe or recommendation according to the manufacturer's specifications) with an amount of a waterproofing element. Thus, in certain exemplary embodiments, the total amount of water and waterproofing element is about 50% by weight based on the gypsum cement base. For example, in a typical mixing procedure: a solid component, 100 g gypsum base, is mixed with a liquid component, 50 g of water. Whereas in a mixing procedure for a modified gypsum cement according to the general inventive concepts comprises 100 g gypsum base+25 g of wax emulsion+25 g of water are mixed to form a modified gypsum cement. In certain exemplary embodiments, the wax emulsion is made up of approximately 50% wax solids, with the remainder water. In certain exemplary embodiments, the total amount of wax is between 5% and 15% of the modified gypsum cement mixture.

In any of the exemplary embodiments, the waterproofing element may be one of a wax emulsion, a silicon emulsion, or mixtures thereof. More generally, the waterproofing element is a chemical composition that reduces gypsum porosity and thus water vapor permeability according to the ASTM E 96 Test Method.

In certain exemplary embodiments, the liquid component (e.g., the water and the waterproofing element) are “pre-mixed.” Thus, the general inventive concepts contemplate the combination of a solid component (i.e., the gypsum base) and a liquid component (comprising the e.g., wax emulsion (comprising wax and water) and water). In certain embodiments, a mixing procedure for a modified gypsum cement comprises mixing 100 g gypsum base with 50 g of a mixture of water and the wax emulsion (this is similar to the previous example, but the wax and water components are already in one component). Further, in certain exemplary embodiments, a modified gypsum cement comprises 100 g of gypsum cement base (solid component) and 50 g of a liquid component comprising a diluted wax emulsion. In either of these exemplary embodiments, the wax itself makes up about 25% by weight of the liquid component of the adhesive/cement and this is equivalent to approximately 8-9% wax in the total adhesive solids of mix. In these embodiments, the liquid component would comprise from about 10% to about 40% wax, including about 20% to about 30% wax, and including about 25% wax.

The general inventive concepts contemplate a method of manufacturing a faced mineral wool insulation product. The method comprises providing a mineral wool substrate and a nonwoven facer, mixing a gypsum cement base, water, and a waterproofing element to form a modified gypsum cement (e.g., a fluorine-free water-resistant adhesive material). When mixing the modified gypsum cement, the waterproofing element displaces a portion of the water that would otherwise be required or recommended for forming a functional/operative gypsum cement. The insulation is fabricated by applying the modified gypsum cement to at least one of the nonwoven facer and the mineral wool substrate and, adhering the nonwoven facer to a surface of the mineral wool substrate.

The general inventive concepts also relate to systems for and methods of insulating a structure with the insulative products described herein. The intrusion of moisture into the region or space between an insulation system (e.g., exterior sheathing) and the underlying substrate (e.g., a roof or wall) can cause significant complications to an industrial facility or a building. In particular, the ingress of water can promote corrosion under the insulation and/or degrade the insulating properties of the system. This issue can be minimized or otherwise ameliorated by use of a modified gypsum cement (e.g., a fluorine-free water-resistant adhesive material) as a glue on the mineral wool products.

Particular embodiments of the waterproofing element include a silicon emulsion, a wax emulsion, or mixtures thereof. In any of the exemplary embodiments, the wax emulsion may comprise a paraffin wax particulate with an average particle size of about 0.5 to about 20 microns in diameter. The waterproofing element (e.g., emulsified wax in the liquid portion of the mixture) substantially reduces the porosity and pore size in the gypsum cement after curing (without wishing to be bound by theory, it is Applicant's belief that the emulsified wax particles can effectively fill the pores that would otherwise be present in the cement in a manner that cannot be achieved by application of conventional waterproofing aids as a coating to a cement). In addition, Applicant has discovered that a particular particle size range for the wax component of the waterproofing element (the particles suspended in the emulsion) provides surprising performance with respect to reduction of water vapor permeability of the modified gypsum cement. Thus, in certain aspects, the particle size may be less than 20 microns, including an average particle size of about 0.1 microns to about 15 microns, including an average particle size of about 0.1 microns to about 10 microns, including an particle size average of about 0.1 microns to about 9 microns, including an average particle size of about 0.1 microns to about 8 microns, including an average particle size of about 0.1 microns to about 7 microns, including an average particle size of about 0.1 microns to about 6 microns, including an average particle size of about 0.5 microns to about 7 microns, including an average particle size of about 1 micron to about 7 microns, including an average particle size of about 1 microns to about 6 microns, including an average particle size of about 1 micron to about 5 microns, including an average particle size of about 2 micron to about 5 microns.

The general inventive concepts are based, in part, on the concept of displacing a portion of the water used to mix the gypsum cement base with a volume of the waterproofing element (e.g., a wax emulsion) rather than merely applying a surface coating to the cement. The cement is then applied to either a surface of the nonwoven facer or a surface of the mineral wool, for example, in a substantially conventional manner such as spraying or direct e.g., blade application. In certain exemplary embodiments, the general inventive concepts contemplate application of the cement to more than one surface of the nonwoven facer, including application up to the entire facer surface. In addition, in certain embodiments, one or more additional waterproofing additives may be added to the cement to provide additional protection.

In certain exemplary embodiments, the waterproofing element is present in the modified gypsum cement (e.g., fluorine-free water-resistant adhesive material) in an amount of less than 40% by weight, based on the weight of the gypsum cement base. In any of the exemplary embodiments, the modified gypsum cement may comprise a gypsum cement base, water, and a waterproofing element in an amount of about 5% by weight of the gypsum cement base to about 40% by weight of the gypsum cement base. In certain exemplary embodiments, the modified gypsum cement comprises a gypsum cement base, water, and a waterproofing element in an amount of about 5% by weight of the gypsum cement base to about 35% by weight of the gypsum cement base. In certain exemplary embodiments, the modified gypsum cement comprises a gypsum cement base, water, and a waterproofing element in an amount of about 5% by weight of the gypsum cement base to about 30% by weight of the gypsum cement base. In certain exemplary embodiments, the modified gypsum cement comprises a gypsum cement base, water, and a waterproofing element in an amount of about 5% by weight of the gypsum cement base to about 25% by weight of the gypsum cement base. In certain exemplary embodiments, the modified gypsum cement comprises a gypsum cement base, water, and a waterproofing element in an amount of about 5% by weight of the gypsum cement base to about 20% by weight of the gypsum cement base. In certain exemplary embodiments, the modified gypsum cement comprises a gypsum cement base, water, and a waterproofing element in an amount of about 5% by weight of the gypsum cement base to about 15% by weight of the gypsum cement base. In certain exemplary embodiments, the modified gypsum cement comprises a gypsum cement base, water, and a waterproofing element in an amount of about 5% by weight of the gypsum cement base to about 10% by weight of the gypsum cement base. In any of the exemplary embodiments, the waterproofing element may be present in the modified gypsum cement in an amount of about 8% to about 10% by weight of the gypsum cement base.

In certain exemplary embodiments, the amount of water and waterproofing element together is from about 40% to about 60% by weight of the gypsum cement base. In certain exemplary embodiments, the waterproofing element is present in an amount no greater than that of the water. In certain exemplary embodiments, the waterproofing element makes up nearly the entire non-gypsum cement base portion (i.e., the liquid portion) of the modified cement, with only a small amount of water needed for formulating the modified gypsum cement.

In certain aspects, the waterproofing element may be present in the modified gypsum cement (e.g., fluorine-free water-resistant adhesive material) in an amount of about 2.5% by weight to about 20% by weight of the modified gypsum cement. For instance, the waterproofing element may be present in the modified gypsum cement in an amount of about 5% by weight to about 20% by weight of the modified gypsum cement, including, for example, about 7% by weight to about 20% by weight of the modified gypsum cement, about 8% by weight to about 15% by weight of the modified gypsum cement, and from about 8% to about 12% by weight of the modified gypsum cement.

The modified gypsum cement (e.g., fluorine-free water-resistant adhesive material) may have a water vapor transmission rate of less than about 0.02 perm-inch, including, for example, a water vapor transmission rate of less than about 0.01 perm-inch, less than about 0.005 perm-inch, less than about 0.002 perm-inch, and less than about 0.001 perm-inch. In certain exemplary embodiments, the modified gypsum cement has a water vapor transmission rate of about 0.02 perm-inch to about 0.0001 perm-inch. In certain exemplary embodiments, the modified gypsum cement has a water vapor transmission rate of about 0.02 perm-inch to about 0.0002 perm-inch. In certain exemplary embodiments, the modified gypsum cement has a water vapor transmission rate of about 0.02 perm-inch to about 0.0005 perm-inch.

As mentioned, the general inventive concepts contemplate a method of insulating a structure. The method comprises mixing a gypsum cement base, water, and a waterproofing element to form a modified gypsum cement (e.g., fluorine-free water-resistant adhesive material), wherein the waterproofing element displaces a portion of the water; providing a plurality of mineral wool insulation members and providing a plurality of nonwoven facers; applying the modified gypsum cement to a surface of each of the mineral wool members; positioning each facer on a surface of a corresponding one of the mineral wool members to form a plurality of faced mineral wool products; and positioning the faced mineral wool products about an exterior of the structure.

### EXAMPLES

The following Examples are provided to better demonstrate specific embodiments of the general inventive concepts. They should not be construed to limit the inventive concepts described herein, which are defined by the claims.

### Example 1: Pore Size Reduction

### Example 1(a)

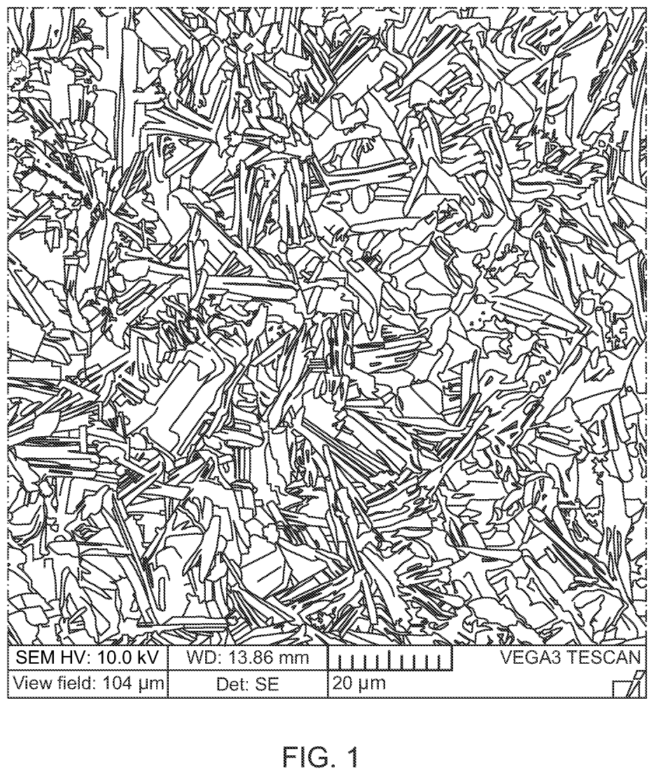

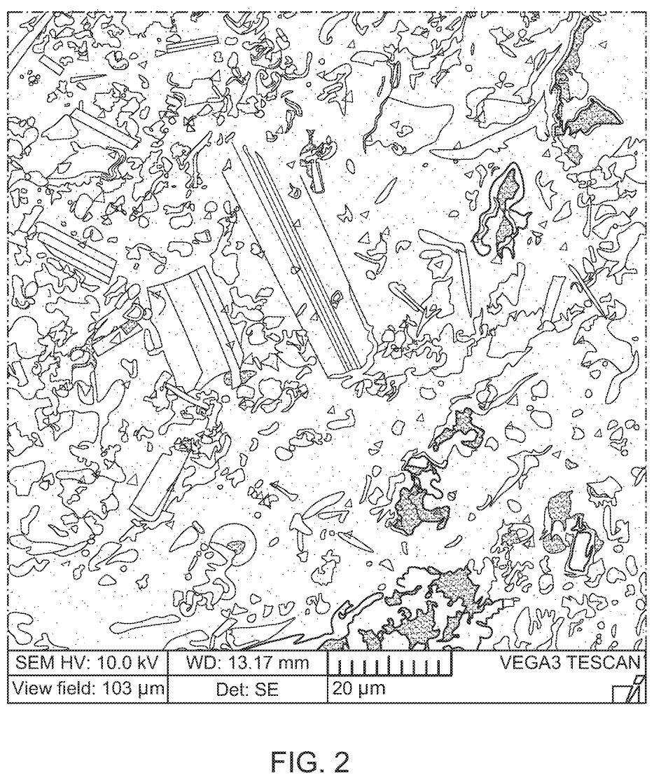

Two formulations of gypsum cement were prepared, a conventional cement made up of Hydrocal® B11 (FIG. 1, control) and a modified gypsum cement including Hydrocal® B11 with a wax emulsion (e.g., a 50% mixture of water and wax) and water (FIG. 2). The modified gypsum cement comprised 30 g gypsum, 12 g wax emulsion, and 3 g water. The SEM images of FIG. 1 and FIG. 2 show a difference in porosity with the latter showing obvious pore reduction/blockage relative to the conventional cement, due to incorporation of the wax emulsion.

### Example 1(b)

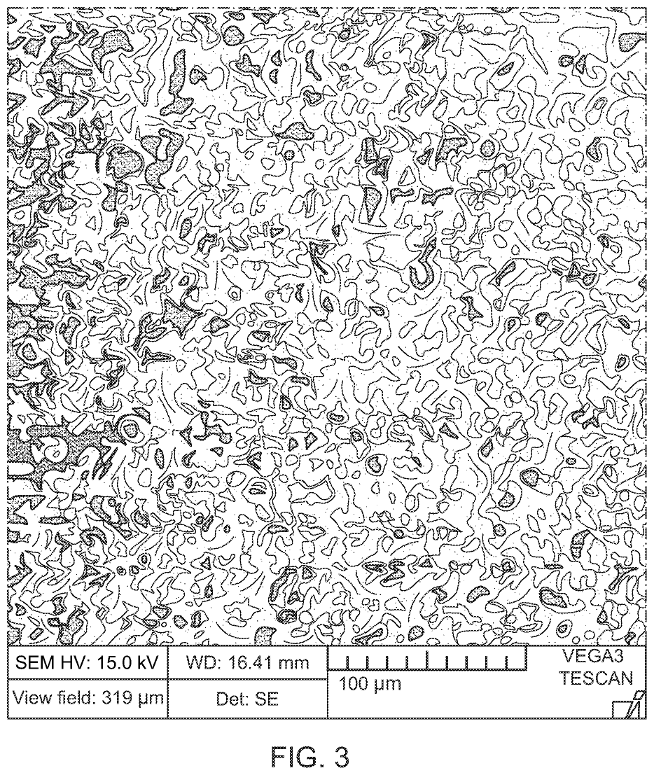

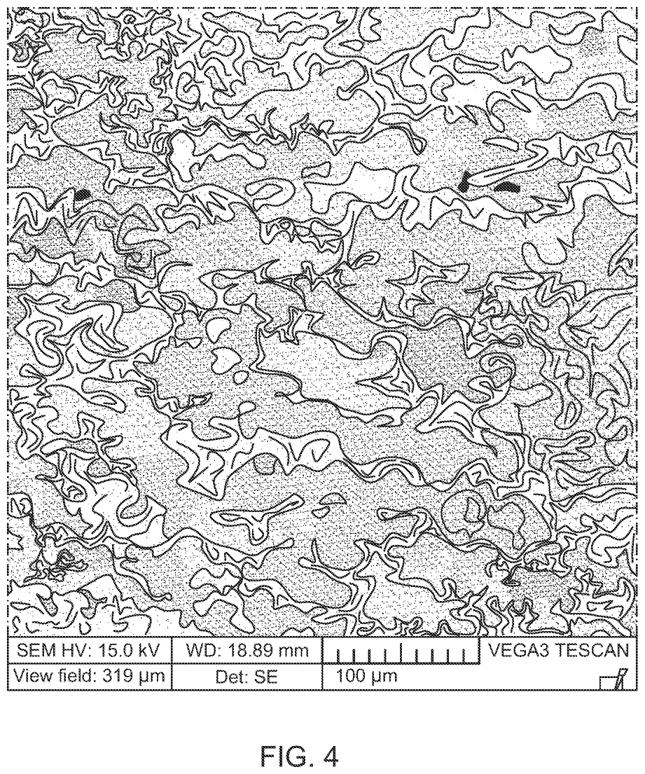

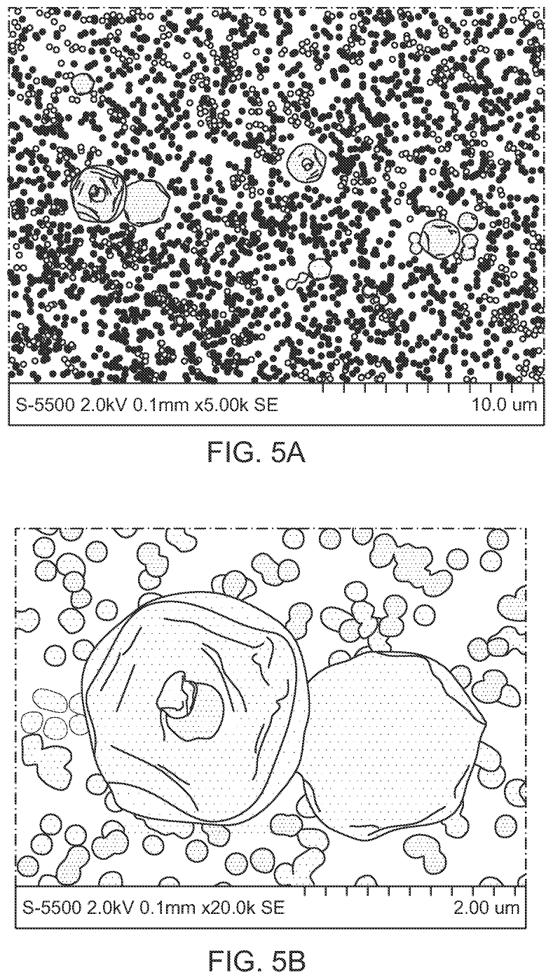

Two formulations gypsum cement were prepared: a conventional cement made up of Hydrocal® B11 (FIG. 3, control) and a modified gypsum cement including Hydrocal® B11 with a silicon emulsion (FIG. 4). The images show a difference in porosity with FIG. 4 showing obvious pore reduction/blockage relative to the conventional cement, due to incorporation of the wax emulsion.

### Example 2

A series of modified gypsum cement adhesives were made using waterproofing elements to displace a portion of the water that would otherwise be used to make the gypsum cement. The modified gypsum cements were tested for water vapor permeability. A conventional cement made from Hydrocal® B11 gypsum cement was also tested as a control. Table 1 shows the results of the permeability test.

TABLE 1

| | % Waterproofing | Perm |
|---|---|---|
| Sample | Element | Inch (Bulk) |
| Hydrocal B11 (control) | 0 | 6.49 |
| Silicon emulsion (50:50 | 10 | 3.51 |
| silicon:water emulsion) | | |
| Silicon emulsion (50:50 | 15 | 2.18 |
| silicon:water emulsion) | | |
| Silicon emulsion (50:50 | 20 | 1.04 |
| silicon:water emulsion) | | |
| Silicon emulsion (50:50 | 20 | 0.99 |
| silicon:water emulsion) | | |
| Silicon emulsion (50:50 | 20 + 15 | 0.44 |
| silicon:water emulsion) + | | |
| Nuva (fluoropolymer) | | |

### Example 3

Modified gypsum cement mixtures were made without water and their water vapor permeability was measured. A conventional cement made from Hydrocal® B11 gypsum cement and water was also tested as a control. Table 2 shows the results of the permeability test.

TABLE 2

| | Amount of | Perm |
|---|---|---|
| Cement Mixture | waterproofing element | Inch (Bulk) |
| Hydrocal ® B11 (control) | 0 | 8.03 |
| 300 g Hydrocal ® B11 + | 200 g (no water) | −0.014 |
| 50:50 wax emulsion | | |
| 300 g Hydrocal ® B11 + | 135 g (no water) | 0.181 |
| 50:50 wax emulsion | | |

### Example 4

A series of modified gypsum cement adhesives were made using waterproofing elements in an amount of 20% by weight based on the gypsum cement base (e.g., the solid portion). The modified gypsum cements were tested for water vapor permeability. A conventional cement made from Hydrocal® B11 gypsum cement was also tested as a control. Table 3 shows the results of the permeability test.

TABLE 3

| Cement Additive | Perm Inch (Joint) |
|---|---|
| Hydrocal ® B11 (none, control) | 0.168 |
| Silicon emulsion (50:50 | 0.017 |
| silicon:water emulsion) 20% | |
| 77030 (anionic wax emulsion) 20% | 0.097 |
| 4983 (ethylene acrylic | 0.111 |
| acid dispersion) 20% | |
| 67235 (non-ionic polyethylene | 0.032 |
| emulsion) 20% | |
| Hydrocer 135 (aqueous amide | 0.052 |
| wax dispersion) 20% | |
| Wax emulsion (40:60 | 0.063 |
| wax:water emulsion) 20% | |
| Nuva 20% | 0.035 |
| Wax emulsion (50:50 | −0.002 |
| wax:water emulsion) 20% | |

### Example 5

A 50:50 wax emulsion and 50:50 silicon emulsion waterproofing elements were used to make a series of modified gypsum cement adhesives in weight % of 10 to 40% by weight of the gypsum cement base. The modified gypsum cements were tested for water vapor permeability. A conventional cement made from Hydrocal® B11 gypsum cement was also tested as a control. Table 4 shows the results of the permeability test.

TABLE 4

| | % Waterproofing | Perm |
|---|---|---|
| Cement Additive | Element | Inch (Joint) |
| Hydrocal B11 (control) | 0 | 0.176 |
| Silicon emulsion | 20 | 0.014 |
| Silicon emulsion | 30 | 0 |
| Silicon emulsion | 40 | 0 |
| Wax emulsion | 10 | 0 |
| Wax emulsion | 15 | 0 |
| Wax emulsion | 20 | −0.002 |
| Wax emulsion | 30 | −0.003 |
| Wax emulsion | 40 | 0.001 |

### Example 6

A series of samples of modified gypsum cement were fabricated according to the general inventive concepts. The samples were tested for requirement of MIL-DTL-24244D, ASTM C795 and NRC Req. Guide 136. Further modified gypsum cement samples were compared to a control group comprising conventional gypsum cement made according to manufacturers' specifications in a 28-day corrosion test. The conventional gypsum cement failed the corrosion testing, whereas the inventive modified gypsum cement made with a wax waterproofing element (in an amount of 8-9% by weight of the modified gypsum cement) passed the corrosion testing as well as MIL-DTL-24244D (SH), ASTM C795 and NRC Req. Guide 136.

The modified gypsum cement according to the invention was applied as a layer on a single side of a nonwoven facer. After drying of the cement, the nonwoven facer is placed under a vertical water flow with an angle of about 45° C., with the coated side facing away from the water flow. Water did not pass through the coated facer. An identical nonwoven facer with no cement layer was likewise placed under the same flow of water and the water flow passed through the nonwoven almost immediately. Thus, the modified gypsum cement directly altered the properties of the facer with respect to water-repellency.

While not wishing to be bound by theory, it is believed that the decrease in the porosity of the modified gypsum cement provides more effective sealing (and water impermeability) to the insulation, while not sacrificing the insulative properties of the system overall. Further, the modified gypsum cement does not sacrifice the adhesive properties of conventional gypsum cement (i.e., cement without the waterproofing element).

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The insulation compositions, and corresponding methods of the present disclosure can comprise, consist of, or consist essentially of the essential elements and limitations of the disclosure as described herein, as well as any additional or optional ingredients, components, or limitations described herein or otherwise useful in mineral wool composition applications.

The insulation compositions of the present disclosure may also be substantially free of any optional or selected ingredient or feature described herein, provided that the remaining composition still contains all of the required elements or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

While the invention has been illustrated and described in detail in the drawings and foregoing description, the same is to be considered as illustrative and not restrictive in character. It should be understood that only the exemplary embodiments have been shown and described and that all changes and modifications that come within the spirit of the invention are desired to be protected.

1. An insulation product comprising:
a unitary substrate including a plurality of interconnected first fibers, a nonwoven facer including a plurality of interconnected second fibers, and a fluorine-free water-resistant adhesive material adhering the substrate and facer together.

2. The insulation product of claim 1, wherein the fluorine-free water-resistant adhesive material comprises a modified gypsum cement.

3. The insulation product of claim 2, wherein the modified gypsum cement comprises a gypsum cement base, water, and a waterproofing element, wherein the waterproofing element is present in the gypsum cement in an amount of 5% to 40% by weight of the gypsum cement base.

4. The insulation product of claim 3, wherein the waterproofing element is present in the modified gypsum cement in an amount of about 5% to about 30% by weight of the modified gypsum cement.

5. The insulation product of claim 3, wherein the waterproofing element is one of a wax emulsion and a silicon emulsion.

6. (canceled)

7. The insulation product of claim 5, wherein the waterproofing element is a wax emulsion having an average particle size of about 0.1 to about 10 microns.

8. (canceled)

9. The insulation product of claim 1, wherein the first fibers are mineral wool fibers and wherein the second fibers are glass fibers.

10. (canceled)

11. A method of manufacturing a faced mineral wool insulation product, the method comprising:
providing a unitary substrate including a plurality of interconnected first fibers and a nonwoven facer including a plurality of interconnected second fibers,
mixing a gypsum cement base, water, and a waterproofing element to form a modified gypsum cement, wherein the waterproofing element displaces a portion of the water;
applying the modified gypsum cement to at least one of the facer and the substrate to adhere the facer to the substrate.

12. The method of claim 11, wherein the modified gypsum cement comprises a fluorine-free water-resistant adhesive material.

13. (canceled)

14. The method of claim 11, wherein the first fibers are mineral wool fibers and wherein the second fibers are glass fibers.

15. (canceled)

16. The method of claim 11, wherein the gypsum cement base is combined with the water and a waterproofing element in a ratio of solid component to liquid components of about 1:1 to 3:1 by weight.

17. The method of claim 11, wherein the waterproofing element is present in an amount of 5% to 40% by weight of the gypsum cement base.

18. (canceled)

19. The method of claim 11, wherein the waterproofing element is a wax emulsion.

20. The method of claim 11, wherein the waterproofing element is a silicon emulsion.

21. The method of claim 11, wherein the waterproofing element is present in an amount of about 5% to about 30% by weight of the modified gypsum cement.

22. A method of insulating a structure comprising:
mixing a gypsum cement base, water, and a waterproofing element selected from a wax emulsion and a silicon emulsion, to form a modified gypsum cement, wherein the waterproofing element displaces a portion of the water;
providing a plurality of fibrous insulation members and providing a plurality of nonwoven facers;
applying the modified gypsum cement to a surface of each of the fibrous insulation members;
positioning each facer on a surface of a corresponding one of the fibrous insulation members to form a plurality of faced mineral wool products; and
positioning the faced mineral wool products about an exterior of the structure.

23. The method of claim 22, wherein the gypsum cement base is combined with the water and a waterproofing element in a ratio of solid component to liquid components of about 1:1 to 3:1 by weight.

24. (canceled)

25. The method of claim 22, wherein the waterproofing element present in an amount of about 5% to about 40% by weight of the gypsum cement base.

26. (canceled)

27. The method of claim 22, wherein the modified gypsum cement is fluorine-free.

28. The method of claim 22, wherein the fibrous insulation members comprise mineral wool insulation members and the plurality of nonwoven facers are glass fiber facers.

29. (canceled)
